(19) United States
(12) Patent Application Publication
(10) Pub. No.: US 2003/0008183 A1
(43) Pub. Date: Jan. 9, 2003

(54) Zero/low emission and co-production energy supply station

(75) Inventor: Michael S. Hsu, Lincoln, MA (US)

Correspondence Address: LAHIVE & COCKFIELD, 28 STATE STREET, BOSTON, MA, 02109, US

(73) Assignee: Ztek Corporation, Woburn, MA (US)

(21) Appl. No.: 09/972,783

(22) Filed: Oct. 5, 2001

Related U.S. Application Data
(63) Continuation-in-part of application No. 09/882,618, filed on Jun. 15, 2001.

(51) Int. Cl. H01M 8/00; H01M 8/06; C01B 3/24; F28D 21/00

(52) U.S. Cl. 429/13; 429/17; 429/19; 429/21; 423/650; 422/198

(57) ABSTRACT

The trend in personal and light commercial transportation vehicle choices is heading toward electric or fuel cell vehicles capable of zero emission. Their demand for electricity to re-charge batteries or hydrogen to operate fuel cells can best be met by variable onsite production of electricity and hydrogen from conventional transportation fuel by an on-site energy supply system employing a conversion device. This approach can result in minimum changes in the present day infrastructure of the automobile and truck service station industry and can avoid any disturbances to the normal operation of the electric power industry. The onsite hydrogen/electricity hybrid conversion device is a reformer and/or a fuel cell. The output of the system can be varied to either meet the demand of hydrogen fuel for fuel cell vehicles or to provide electricity for charging batteries used on the electrical vehicles. The onsite distributed energy supply system utilizing a high temperature solid oxide fuel cell system for electric generation and an integral steam reforming system for hydrogen production are the most desirable approaches. One such energy supply system allows the total CO₂ capture for sequestration or commercial uses, while concomitantly providing for high system efficiency and full system utilization. The CO₂ collection feature promotes the commercial realization of zero/low emission energy supply for onsite installations.

### RELATED APPLICATIONS

This application is a continuation-in-part patent application of prior U. S. patent application Ser. No. 09/882,618, filed Jun. 15, 2001, entitled ZERO/LOW EMISSION AND CO-PRODUCTION ENERGY SUPPLY STATION, the contents of which are herein incorporated by reference.

### BACKGROUND OF THE INVENTION

The present invention relates to energy supply systems, and more particularly relates to an energy supply system that employs an energy supply station for producing and delivering hydrogen and/or electricity to users such as vehicles.

Energy supply stations are known and exist. A conventional energy supply station is a stand-alone station that can be configured to provide a consumable fuel, such as a hydrocarbon fuel or hydrogen. Alternatively, the station can be configured to generate electricity. A drawback of these types of stations is that they provide only single purpose services, either delivering fuel or producing electricity. Furthermore, they do not, along the supply chains of fuel and electricity, reduce the overall levels of emissions discharged into the environment.

Moreover, environmental and political concerns associated with traditional combustion-based energy systems and stations, such as internal combustion engines or any onsite and central electricity generation plants, are elevating interest in alternative clean (e.g., green) types of energy systems. Thus, there exists a need in the art for a relatively clean high performance energy supply station. In particular, an improved low emission station employing one or more types of chemical converters would represent a major improvement in the industry. Additionally, a low emission energy supply station that is capable of delivering hydrogen fuel and/or electricity to users such as vehicles would also represent a major advance in the industry.

### SUMMARY OF THE INVENTION

The station of the present invention employs a hybrid reformer/fuel cell system used to create a zero/low emission service station utilizing existing transportation fuel infrastructure without burdening the existing electric power infrastructure, while concomitantly maintaining an environmental balance that eliminates or significantly reduces the CO₂ component from greenhouse emissions. Traditional transportation fuels such as gasoline, diesel fuel, natural gas, methanol or biogas, are converted to hydrogen and electricity for use in zero or low emission vehicles, such as fuel cell vehicles, battery powered vehicles or a hybrid of such vehicles. Excess electric power generated by the station can be utilized onsite, nearby or dispensed to an electric power grid.

The hybrid reformer/fuel cell system can be a two in one system providing both hydrogen and electricity, or can be configured to provide either electricity or hydrogen. The two in one system arrangement is advantageous since it can be configured to share major components between a reformer subsystem and a fuel cell subsystem, and is capable of providing diverse energy services in a baseload operation. This allows the system operational efficiency, cost effectiveness and versatility. A major attractiveness of the system is its environmental advantage—zero emission of SO_{X}, NOₓ, or C₂, in addition to the system's capital and operational economy.

The hybrid system can employ a chemical converter. The chemical converter may be operated as a reformer. When operated as a steam reformer, thermal energy for the endothermic steam reforming reaction is provided from an external heat source by radiation and/or convection. A shift reaction from the molecular species of hydrogen, carbon monoxide and steam produces a stream of hydrogen, carbon dioxide and steam. Allowing the steam to condense, pure hydrogen can be extracted from the shift reaction stream and carbon dioxide can be collected for sequestration, including commercial uses. This addresses global warming issues by employing a station that produces energy with zero/low emissions.

When the chemical converter is operated as a partial oxidation or auto thermal type reformer, a fraction of the natural gas is oxidized in the presence of a combustion catalyst and a reforming catalyst. This produces a mixture of hydrogen, carbon dioxide, steam and nitrogen. The CO₂ isolation and collection is not as easy due to the presence of nitrogen diluents derived from the air required for the combustion heating.

The chemical converter may also be operated as a fuel cell. When operated as a fuel cell, electrical energy is generated with fuel supplies such as hydrogen or natural gas. When a high temperature fuel cell is used, the fuel stream is converted into CO₂ and steam without the dilution by nitrogen from the air. Following the separation of steam by condensation, carbon dioxide can be easily collected, isolated or removed for sequestration, including commercial uses.

The present invention forms a zero emission station with the combination of a steam reformer and a high temperature fuel cell with the capacity of each being determined by the thermal energy matching of the two, wherein the reforming reaction is endothermic and the fuel cell reaction is exothermic. The reformer, as a result, has a larger capacity than the chemical matching needs of the fuel cell. Thus the excess reformed fuel can be made available for other station components, or can be delivered to a vehicle. The combination of the steam reforming and the high temperature fuel cell operation also allows for the easy capture of CO₂.

The present invention also pertains to a chemical converter configured for enhancing system operational efficiency and versatility of the overall station. The chemical converter can be disposed within a containing vessel that collects hot exhaust gases generated by the converter for delivery to a cogeneration bottoming device, such as a gas turbine. The bottoming device extracts energy from the waste heat generated by the converter yielding an improved efficiency energy system. Bottoming devices can also include, for example, a heating, ventilation or cooling (HVAC) system.

The present invention addresses the current need for clean energy production, while concomitantly addressing the need for producing energy for use by low or zero emission vehicles, which would be powered by either batteries, hydrogen fuel cells, or a combination of both. Prior to the present invention it has been possible to generate hydrogen by reforming processes in both a remote central production facility and on-site at existing automobile or truck service stations. The hydrogen can be used as fuel by low or zero emission vehicles such as hydrogen fuel cell powered vehicles. Hydrogen production can also be performed by electrolysis using utility grid power. The utility grid power can also be used to charge the batteries of the electric vehicles. This comes with substantial cost, while also burdening the electric power infrastructure. Moreover, the conventional systems for producing hydrogen generate unwanted CO₂ emissions. The continued release of CO₂ greenhouse gases at the fuel production and electric generation stations eliminates the benefits achieved from using low or zero emission vehicles. The above costs and corresponding emissions are counter-productive to the savings achieved from the use of zero/low emission vehicles.

In conventional reforming processes, including steam reforming, partial oxidation reforming or auto thermal reforming, a fraction of the natural gas is oxidized in the presence of a combustion gas, such as air, utilized by a heat source to provide heat for the endothermic reforming processes. The exhaust released into the atmosphere invariably consists of a mixture of carbon dioxide, steam and nitrogen. The carbon dioxide cannot be easily separated from the nitrogen, and hence cannot be economically sequestered. The above is true for present conventional power plants using coal, natural gas or oil.

The present invention achieves the foregoing objects and advantages by providing an energy supply station for converting hydrocarbon fuel into hydrogen and/or electricity for subsequent delivery to users, such as vehicles. The station comprises a chemical converter for processing the fuel to form an output medium containing carbon dioxide, a separation stage for separating a chemical component from the output medium, a collection element in fluid circuit with the separation stage for collecting the carbon dioxide, and a vehicle interface for interfacing with the vehicle. The vehicle interface allows for the exchange of electricity and/or hydrogen between the vehicle and the station. The station can also be configured to deliver hydrogen to another installation, or to deliver power to an electric power grid.

According to one aspect, the energy supply station includes a fuel treatment element for pre-treating the fuel prior to introduction to the chemical converter. The system can also include a vaporizer for heating and vaporizing a liquid reforming agent prior to introduction to the chemical converter, and/or an evaporator for heating and evaporating the fuel prior to introduction to the chemical converter. The vaporizer can include a steam boiler or a heat recovery steam generator.

According to another aspect, the energy supply system can include a mixer for vaporizing the reforming agent and evaporating the fuel, and/or to mix the fuel and the reforming agent.

According to another aspect, the energy supply system can further include a secondary heating stage disposed between the vaporizer and the mixer for heating the reforming agent prior to introduction to the mixer.

According to still another aspect, the chemical converter can comprise a reformer for reforming fuel in the presence of a reforming agent, and for generating an output medium containing hydrogen, water and carbon monoxide. The reformer converts the fuel into hydrogen and carbon monoxide as a product of an intermediate reaction that occurs therein. The reforming agent can include air, water or steam. The separation stage in this arrangement can be adapted to isolate individually the hydrogen, water and carbon dioxide in the output medium.

According to still another aspect, the energy supply station, further comprises a treatment stage for treating a reforming agent prior to introduction to the reformer. The treatment stage can comprise a de-ionizer or a vaporizer. The de-ionizer processes the reforming agent with a de-ionizing resin or by a reverse osmosis technique.

According to yet another aspect, when the chemical converter is a reformer, the vehicle interface is configured to deliver hydrogen to the vehicle. When the chemical converter is a fuel cell, the vehicle interface is configured to deliver electricity to the vehicle.

According to still another aspect, the energy supply station can include a generator, which can include a fuel cell or a gas turbine assembly. The generator can be selectively coupled to the vehicle interface to deliver electricity to the vehicle.

According to still another aspect, the station can include a de-sulfurization unit for removing sulfur from the input fuel or output medium, a low and/or high temperature shift reactor for converting carbon monoxide and steam within the output medium into carbon dioxide and hydrogen, and/or a hydrogen processor for processing hydrogen present within the output medium.

According to still another aspect, a reforming apparatus is provided for reforming hydrocarbon fuel into hydrogen, optionally without emitting carbonous gas into the atmosphere. The reforming apparatus includes an endothermic reformer for reforming the fuel and producing an output medium including hydrogen, and optionally a heater for providing heat to the reformer, such that a portion of the output medium is used as an energy source for the heater.

According to still another aspect, a method for reforming hydrocarbon fuel into hydrogen is provided having the steps of providing the fuel to an endothermic reformer, utilizing a heater to provide heat to the reformer, reforming the fuel, thereby producing an output medium including hydrogen, and directing a portion of the output medium to power the heater. Optionally, carbonous gas is prevented from releasing to the atmosphere.

### BRIEF DESCRIPTION OF THE DRAWINGS

The foregoing and other objects, features and advantages of the invention will be apparent from the following description and apparent from the accompanying drawings, in which like reference characters refer to the same parts throughout the different views. The drawings illustrate principles of the invention.

FIG. 1 is a schematic illustration of a low or zero emission energy supply station according to the teachings of the present invention.

FIG. 2 is a schematic block diagram illustrating the process flow of the reactants and exhaust in a low emission energy supply station.

FIG. 3 is a schematic block diagram illustrating the fluid and energy flow in a low emission energy supply station of the present invention.

FIG. 4 is a schematic block diagram illustrating the fluid and energy flow in an optional zero/low emission reforming apparatus of the present invention.

### DESCRIPTION OF ILLUSTRATED EMBODIMENTS

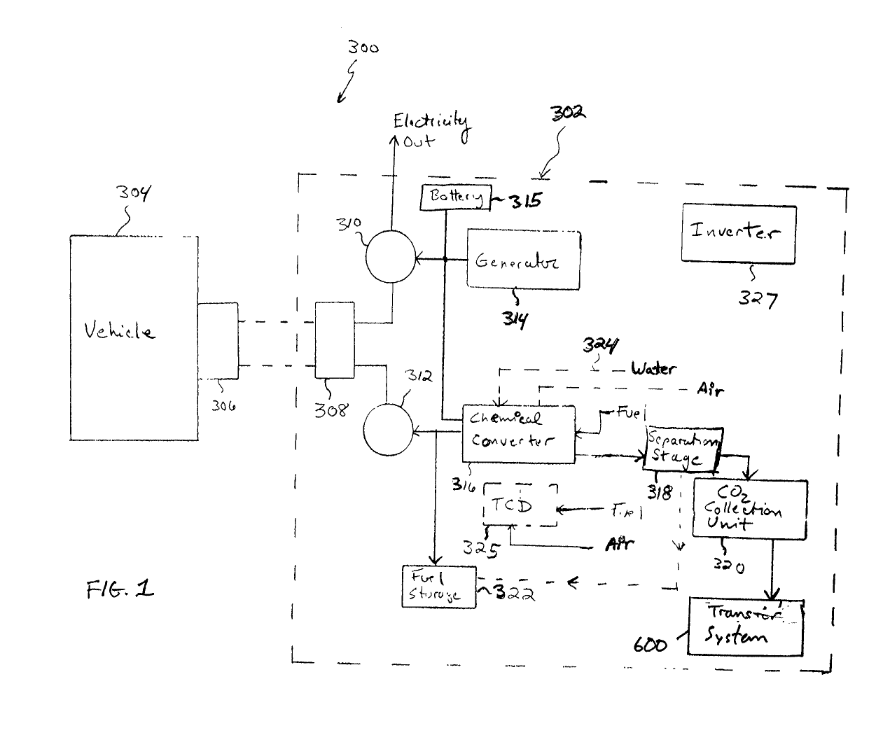

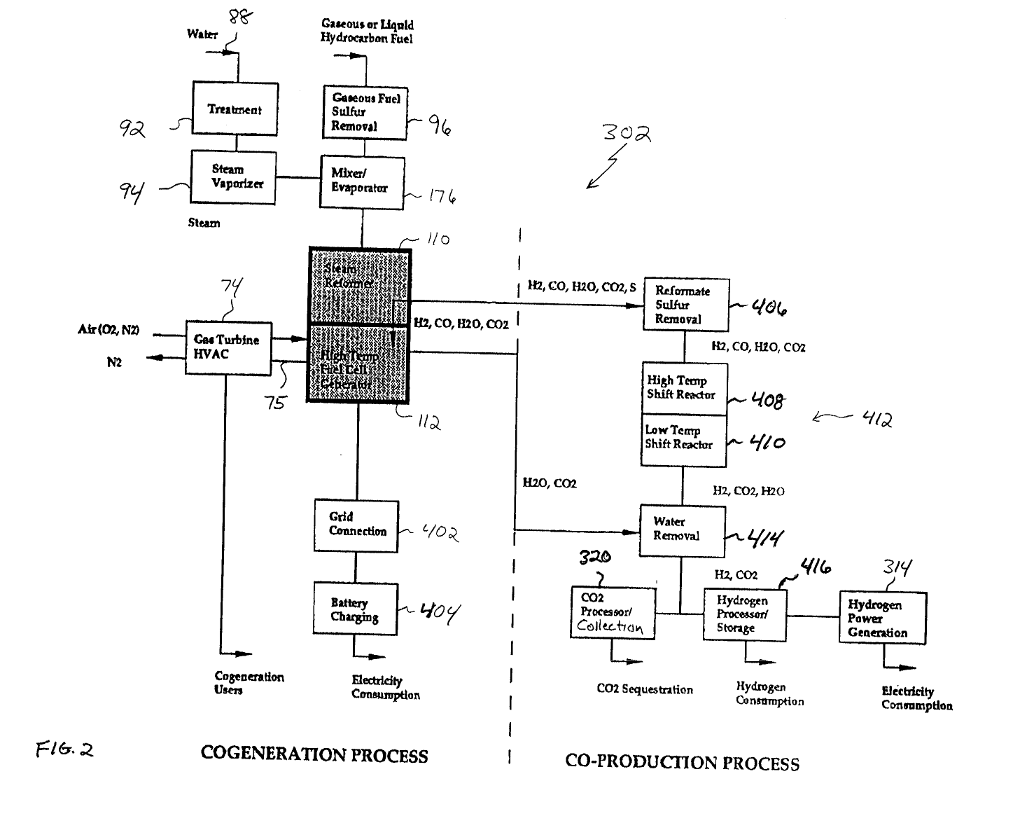

The present invention provides for a zero/low emission energy supply station (ZES) that is adapted to primarily produce hydrogen and/or electricity for subsequent delivery to or use by a zero emission vehicle (ZEV), while at the same time eliminating or greatly reducing CO₂, SOₓ, and NOₓ emissions. The approach utilizes existing energy industry infrastructure with little or no changes. The supply station 302 can be adapted to include one or more components associated with the energy system 300 of FIGS. 1 and 2.

FIG. 1 illustrates an environmentally benign (e.g., low emission) energy supply system 300 according to the teachings of the present invention. As used herein, the term zero or low emission is intended to include a supply station that has carbon emissions (including CO, CO₂ and CₓH_{y} species) that are 50% less than the carbon content of the hydrocarbon fuel being dispensed or consumed at the station, preferably below 25%, and most preferably close to or equal to 0%. The illustrated system 300 includes a zero/low emission vehicle 304 and a zero/low emission energy supply station 302. The station can be any size station having any desired power or hydrogen generating capacity or rating. The term “vehicle” as used herein refers to all means or modes of transportation including, but not limited to, for example automobiles, trucks, buses, trains, marine vessels, airplanes, spacecraft, transporters and the like. According to a preferred practice, the illustrated vehicle is a mobile fuel cell vehicle that employs a hydrogen consuming fuel cell and/or a rechargeable battery. Examples of vehicles suitable for use with the present invention are disclosed in U.S. Pat. No. 5,858,568 and U.S. Pat. No. 5,332,630, the contents of which are herein incorporated by reference. In particular, U.S. Pat. No. 5,858,568 discloses the ability of a mobile fuel cell power system to couple to an off-board station. A transporter can be any apparatus configured for storing or transporting hydrogen or electricity. The illustrated vehicle 304 can include a vehicle access panel 306. The access panel 306 allows the zero/low emission energy supply station 302 to directly interface with the vehicle 304.

The illustrated energy supply station 302 can include a variety of components. According to one embodiment, the station includes a station vehicle interface 308 that is adapted to communicate with the vehicle access panel 306. The vehicle interface can be any mechanical, electrical, electromechanical, or chemical component that allows, enables or facilitates the station to interface with the vehicle in order to deliver hydrogen and/or electricity thereto. The vehicle interface 308 can optionally communicate with an optional power meter 310 and/or an optional fuel meter 312. The illustrated fuel meter 312 meters the amount of fuel exchanged between the station 302 to a fuel tank resident within the vehicle 304. The illustrated power meter 310 measures the amount of electricity exchanged between the station to the vehicle 304. According to an alternate embodiment, the electricity generated by the station 302 can be applied for charging a battery 315, or for stationary uses, such as onsite uses, uses by neighboring residential or commercial installations, or can be supplied to a local power grid through the power meter 310 or any other suitable structure.

The illustrated clean energy supply station 302 can further include a generator 314 that is in communication with the power meter 310. The generator can include any apparatus suitable for generating power or electricity, examples of which can include a fuel cell, gas turbine, steam turbine, IC generator, bottoming devices, and like apparatus. As used herein, the phrase bottoming device is intended to include any suitable structure that can be coupled to receive either power, electricity, exhaust, or thermal energy from another station component. The generator is configured to produce electricity, which can be supplied to the vehicle 304 through the vehicle interface 308. The station 302 can also include an inverter 327 for inverting any electricity generated in the station. For example, if the chemical converter is a fuel cell, the inverter can invert the DC electricity generated thereby into AC electricity.

The energy supply station 302 further includes a chemical converter 316. The chemical converter 316 can be either a reformer or a fuel cell, or a hybrid system employing multiple converters for providing both functions. The chemical converter is in fluid communication with a separation stage 318, which in turn is in fluid communication with a carbon dioxide collection unit 320. The collection unit can be any device or apparatus suitable for collecting and/or storing carbon dioxide. The separation stage 318 is adapted to remove one or more constituents from the output medium generated by the chemical converter 316 or some other system component. The illustrated chemical converter can also be disposed in thermal communication with a thermal control device 325 for system startup and thermal control during steady state operation. The chemical converter can be positioned to receive water, air or fuel depending upon the function of the chemical converter. The thermal control device is in fluid communication with a fuel and air source.

According to one practice, the illustrated chemical converter 316 can be a fuel reformer. The reformer is adapted to receive the hydrocarbon fuel and a reforming agent 324, such as water, air, steam, oxygen or carbon dioxide. Those of ordinary skill will recognize that the water can be supplied to the reformer as steam. The reformer employs a catalyst material to promote the reformation of the hydrocarbon fuel into simpler reaction species. For example, the hydrocarbon fuel can be catalytically reformed into an output medium having a mixture of H₂O, H₂, CO, and CO₂. The illustrated reformer reforms the fuel in the presence of the reforming agent to produce a relatively pure fuel stock. An example of a reformer suitable for use in the illustrated energy supply system 300 is described in U.S. Pat. No. 5,858,314, the contents of which are herein incorporated by reference. According to one practice, a plate-type compact reformer can be employed in the system, although those of ordinary skill will recognize that other types of reformers, including conventional type reactant bed and cylindrical reformers, can be employed. The heat necessary for the reforming process can be supplied internally by partial oxidation of the fuel, such as a hydrocarbon fuel, or supplied externally by a heat source, such as by the thermal control device 325, a fuel cell or other heat generating type apparatus. The heat can be supplied to the reformer by radiation, conduction or convection.

The illustrated thermal control device 325 can include any selected structure for interfacing with the chemical converter 316 in order to control, adjust or regulate the temperature thereof, or of another component of the system 300. Those of ordinary skill will readily recognize that the thermal control device 325 can operate as a heating device, for example upon system start-up, or as a heat sink or cooling device during steady state operation. Examples of a suitable heating device are set forth in U.S. Pat. No. 5,338,622, the contents of which are herein incorporated by reference.

When operating the reformer as a steam reformer, a preferred mode of operation, it receives a reactant gas mixture containing hydrocarbon fuel and steam. Thermal energy for the endothermic steam reforming reaction is provided externally by radiation and/or convection. This produces hydrogen in a fuel stream separate from the heating medium. The equations below illustrate the chemical reactions performed by the reformer with natural gas at a temperature less than 1000° C., using recoverable waste heat from the fuel cell or renewable thermal energy such as geothermal and concentrated solar; or nuclear thermal sources.

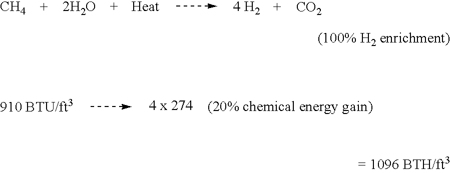

The equations below illustrate the chemical reactions performed by the reformer with gasoline at a temperature less than 1000° C., using recoverable waste heat from the fuel cell; renewable thermal energy such as geothermal and concentrated solar; or nuclear heat sources.

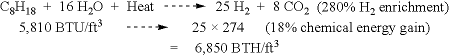

As shown by the equations above, when the chemical reaction and energy balance are carried out in full, the net energy represented by the hydrogen is high than the fuel energy input to the reaction. At least a net near about 20% chemical energy content gain can be achieved. Thus, the process produces hydrogen from fuel and water with a hydrogen yield greater than unity with respect to the hydrogen content of the fuel. The extra hydrogen is stripped from the water, and the incremental energy is derived from the waste exhaust of the fuel cell reaction. Essentially, net hydrogen is produced from the water supply. The system configuration and components create at least about a 50% gain in hydrogen yield, and preferably between about a 50% and about a 250% gain in hydrogen yield, from the fuel.

The separation stage can comprise one or more stages adapted to remove, separate or isolate individually the water, hydrogen and carbon dioxide from the output medium. Following removal or separation of the steam from the reformer output medium, such as by condensation techniques, hydrogen can also be extracted from the stream by the separation stage 318, and the remaining carbon dioxide can be collected, sequestered or stored in the carbon dioxide collection unit 320. The output reformed fuel, or hydrogen, generated by the reformer can be supplied to the vehicle 304 through the vehicle interface 308. Alternatively, the hydrogen can be stored in the fuel storage unit 322 resident within the station 302. The fuel storage unit 322 can be any suitable storage element, and can be formed of metal or fiberglass, or from a polymer-lined composite material, such as the Type IV TriShield storage tank of Quantum Technologies, Inc., U.S.A.

When the steam reforming described above is employed, air is not mixed with the fuel. Therefore, there is no nitrogen being introduced to the converter, eliminating a need for nitrogen removal from the output medium. This is diametrically opposite to a partial oxidation or auto thermal reforming reformer, where a fraction of the natural gas is oxidized in the presence of a combustion and reforming catalyst. The reformer consequently produces a mixture of hydrogen, carbon dioxide, steam and nitrogen.

Those of ordinary skill will readily recognize that a treatment unit, such as a de-ionization or vaporizer unit, can be provided to pretreat the reforming agent 324 prior to introduction to the chemical converter 316. The type of reforming agent processor can be selected depending upon the type of reforming agent used, or the type and/or configuration of the chemical converter 316. If the reforming agent is water, the processor can process the agent with a de-ionizing resin device or with a reverse osmosis device.

The illustrated separation stage 318 is adapted or configured to separate or remove one or more selected components from the output medium generated by the chemical converter 316. According to one practice, the separation stage 318 is adapted to remove carbon dioxide from the output medium. The carbon dioxide can then be captured and collected within the carbon dioxide collection unit 320 for further sequestration steps.

The separation stage 318 can be any suitable stage adapted or configured for separating one or more components from the output medium of the chemical converter. The separation stage can be configured for separating hydrogen or carbon dioxide from the output medium. The separation stage can be configured to separate hydrogen or carbon dioxide from the output medium according to a number of techniques, including but not limited to chemical or physical absorption, adsorption, low temperature distillation, high pressure liquefaction, membrane, enzyme, and molecular sieve type separation techniques. One example is an enzymatic process technique conducted in an aqueous environment that transforms CO₂ and H₂O into H⁺ and HCO₃⁻. The bicarbonate (HCO₃⁻) is an environmentally safe species suitable for controlled disposal.

According to a further embodiment of the invention, an alternative technique for the carbon dioxide sequestration is disposition to a sub-surface ocean level following its collection and optionally transporting from numerous land-based energy supply stations to the ocean shores. According to a variation of this embodiment, the carbon dioxide is deposited at an ocean depth of at least 1000 feet or deeper. The transporting of the safety-benign carbon dioxide gas can be performed by a transfer system 600. The transfer system 600 can include any selected or combination of fluid conduits, such as underground pipes or ducts, examples of which are pipes or ducts used in the transporting of water and sewage according to current practices. The transfer system 600 can involve new pipes or ducts or involve existing sewage or other available lines. Optionally or in addition, the transfer system can involve any suitable land or marine vehicle, such as a train or truck, thereby transporting carbon dioxide by containers. Furthermore, before entering the transfer system or while within the transfer system, the carbon dioxide may be pressurized or liquefied for transport or storage. There are commercial usages for the collected carbon dioxide including the bottling industry and sources for various chemical feed stocks.

When the chemical converter 316 functions as a reformer, the reformed fuel can be stored in the fuel storage unit 322 or in a storage unit in the vehicle 304. The storage units can include appropriate storage media suitable for storing or transporting hydrogen. The storage media can also refer to the manner in which the hydrogen is transported within the container or the state of the hydrogen within the container. The hydrogen can be stored or transported in a compressed gas state (H₂), a solid state (such as a metal hydride), an aqueous state (such as a liquid hydride including NaBH₄, KBH₄, and LiBH₄), or in a liquid or refrigerated state (such as liquefied hydrogen). The aqueous storage or transport of hydrogen can employ any suitable chemical reaction, such as by reacting NaBO₂ with 4H₂ to form NaBH₄ and 2H₂O. The release of hydrogen occurs in the reverse direction in the presence of any suitable known catalyst. The aqueous solution is a particularly suitable form of storing hydrogen since existing practices of gasoline storage and transporting vehicles can be employed.

The energy supply station 302 can also include apparatus for further conditioning the fuel or reformed fuel, such as a desulfurization unit, a hydrogen shift reactor, a hydrogen polisher, or a hydrogen compressor for compressing hydrogen. The compressor can be a mechanical or an electrochemical compressor, such as a phosphoric acid, alkaline, or proton exchange membrane device.

In operation, the hybrid energy supply station 302 can generate hydrogen and/or electricity that can be supplied to the vehicle 304. When the chemical converter is a reformer, the station includes means for supplying a reforming agent, such as air, water, or both, and fuel to the reformer. The reformer output medium generally includes hydrogen rich gas. The output medium can then be passed through the separation stage to separate one or more constituents, such as hydrogen or CO₂. The hydrogen can then be transferred to a zero or low emission vehicle 304 through the vehicle interface 308. The fuel meter 312 can determine the amount of fuel supplied to the vehicle 304. The hydrogen fuel can also be provided to the generator 314, which in turn generates electricity and exhaust. The electricity can also be supplied to the vehicle 304 through the vehicle interface 308.

The chemical converter 316 can also be operated as an electrochemical device, such as a fuel cell. When operated as a fuel cell, the device consumes fuel and an oxidant to generate electrical energy and a high temperature output medium. When a solid oxide fuel cell is used, the fuel stream output medium includes carbon dioxide and steam without being diluted by nitrogen. Following removal of steam from the output medium by the separation stage 318, such as by condensation techniques, the remaining carbon dioxide can be collected and stored in the collection unit 320. Moreover, the high temperature output medium can also be conveyed to the generator, which in turn generates additional electricity. The electricity can be supplied to the vehicle 304 through the interfaces 306 and/or 308. The term fuel cell as used herein is intended to include any suitable fuel cell, such as the plate-type fuel cell described in U.S. Pat. Nos. 5,501,781 and 4,853,100, the contents of which are herein incorporated by reference, or a rectangular, square or tubular type fuel cell. The fuel cell can be either a molten carbonate fuel cell, a phosphoric acid fuel cell, an alkaline fuel cell, or a proton exchange membrane fuel cell, and is preferably a solid oxide fuel cell.

According to another practice, the chemical converter can be disposed within a containing vessel that collects hot exhaust gases generated by the converter for delivery to a generator or bottoming plant, such as a gas turbine. A suitable vessel adapted to enclose the chemical converter 316 is disclosed and described in U.S. Pat. No. 5,501,781, the contents of which are herein incorporated by reference. The bottoming device extracts energy from the waste heat generated by the converter yielding an improved efficiency energy system. Bottoming devices can also include, for example, a heating, ventilation or cooling (HVAC) system.

Those of ordinary skill will readily recognize that any suitable number of chemical converters, thermal control devices, generators and separation stages can be employed. According to a preferred embodiment, the station 302 includes one or more fuel cells and one or more reformers for generating hydrogen and electricity.

A significant advantage of the present invention is that the energy supply station can be operated in a hybrid mode, thereby generating and supplying hydrogen and electricity to the zero or low emission vehicle 304. According to one practice, the reformer generates amounts of reformed fuel larger than that required by the fuel cell. Thus, the excess reformed fuel can be made available for hydrogen production.

Another advantage of the energy supply station 302 of the present invention is that it facilitates or promotes the use of zero or low emission electric or fuel cell vehicles. The station 302 of the present invention can supply electricity and hydrogen for the vehicle 304 by converting onsite conventional transportation fuel. Such an approach allows the station to employ or interface with present day infra-structure, such as electric supply grids and fuel supply trucks and pipelines. Moreover, the onsite distributed energy supply system of the station 302 utilizes, according to one aspect, a high temperature fuel cell system for electric generation and a steam reforming system for hydrogen production. These systems are desirable approaches since they offer high system efficiency, high system utilization, and relatively easy carbon dioxide sequestration. By simplifying carbon dioxide sequestration, the station promotes the formation and use of zero/low emission installations.

FIG. 2 is a schematic block diagram illustrating the process flow of the reactants and output medium according to the teachings of the present invention. Like reference numerals are used throughout to designate like components. The illustrated system or station 302 is intended to be simply illustrative of the operation and interrelationship of certain components of the foregoing systems. Although illustrated with multiple different stages and components, the system can have any selected number of components and arrangements thereof. The illustrated arrangement is merely illustrative and is not intended to be construed in a limiting sense. The description of stages and components previously described need not be reproduced below. As illustrated, the system employs two chemical converters, a fuel cell 112 and a reformer 110.

The reforming agent 88, such as water, is introduced to the treatment stage 92, and is then transferred to the vaporizer 94. The vaporizer heats the water and converts it to steam, which is then conveyed to the mixer 176. The vaporizer can be a steam boiler or a heat recovery steam generator. According to an alternate optional embodiment, a secondary heater can be positioned between the vaporizer 94 and the mixer 176 to further heat the gaseous reforming agent exiting the vaporizer prior to introduction to the mixer 176. The fuel is introduced to the treatment stage 96, and is then introduced to the mixer 176. The mixer 176 mixes the reforming agent and the fuel prior to introduction to the reformer 110. The mixer also serves as an evaporator if liquid fuel is used and the steam is the source of heat for this process. The evaporator heats and evaporates the fuel. The reformer 110 preferably reforms the fuel in the presence of the reforming agent and a catalyst to create an output medium having one or more of H₂O, H₂, CO, CO₂, and S. The hydrogen and/or other components of the output medium can be introduced to the fuel cell 112. The fuel cell electrochemically converts the reformed fuel in the presence of an oxidant into electricity while concomitantly producing an output medium or exhaust primarily comprised of H₂O and CO₂. The fuel cell output medium 75 can be a high temperature medium that can be transferred to a bottoming plant, such as the gas turbine 74 or an HVAC unit. The bottoming plant can produce exhaust, such as nitrogen, and electricity that can be conveyed to other sites or users. Conversely, the bottoming plant can receive an input medium, such as air, and produce an output stream that is introduced to the fuel cell 112. The output stream can be a medium compressed by the bottoming plant, or an output effluent suitable for processing by the fuel cell. The electricity generated by the fuel cell can be extracted therefrom and used for any desired purpose. For example, the electricity can be used onsite, used nearby, supplied to an electrical utility grid 402 for normal power purposes, or it can be used to charge a battery 404, such as the type employed in electric vehicle 304.

The output medium of the reformer 110 can then be conveyed to a second treatment stage 406. The treatment stage 406 can be any suitable stage for processing or conditioning the fuel, examples of which include a desulfurization unit. The desulfurization unit can employ ZnO to absorb or remove sulfur from the output medium. The treated output medium can then be introduced to an additional treatment stage 412, which for example can include high and low temperature shift reactors converting CO in the presence of H₂O into H₂ mixed with CO₂. The high temperature shift reactor can comprise a reactant bed of Fe₂O₃/Cr₂O₃ material that chemically reacts with the output medium, and the low temperature reactant bed can comprise a reactant bed of CuO/ZnO for chemically reacting with the output medium. Heat exchangers can be provided at appropriate locations to ensure that the proper temperature is attained during the processing steps.

The system 300 further includes a water separation stage for removing water from the output medium. The water can be removed for example by known condensation techniques.

The output medium of the zero/low emission hybrid electric supply station then typically includes H₂ and CO₂, which can be introduced to a separation stage. For example, the separation stage 318 of FIG. 1 separates either CO₂ or H₂ from the output medium. According to one practice, the separation stage separates hydrogen from the output medium according to any of the above-described art known techniques. The CO₂ remaining in the output medium with hydrogen rich gas, without the dilution of extraneous and unwanted N₂, can be easily sequestered and stored in the collection unit 320. This forms a zero/low emission station since the CO₂ is not vented or exhausted into the environment. The above technique utilizing steam assisted reforming and the waste heat derived from the high temperature fuel cell make it possible for simple CO₂ isolation. The N₂, a benign species in the remaining oxidizer stream of the fuel cell operation, is passed along through a bottoming device, such as a gas turbine and HVAC stage, and vented separately to the ambient environment.

The zero emission system of the invention employs a combination of the above steam reformer and high temperature fuel cell, where the capacity of each is determined by the thermal energy matching of the two, such that the reforming reaction is endothermic and the fuel cell reaction is exothermic. The reformer, as the result, has a bigger capacity than the chemical matching needs of the fuel cell. Thus the excess reformed fuel can be made available for hydrogen production. The combination of the steam reforming and the high temperature fuel cell operation allows for the total capture of CO₂. Moreover, the system of the present invention achieves total system energy balance without additional combustion heating. The ratio of the co-production of electrical energy to hydrogen fuel energy in this environmentally benign system is about 2 to 1. The system 300 has an electrical efficiency of about 45% and a chemical production rate of about 25% resulting in a system co-production efficiency of about 70%. This can provide the electricity necessary to charge the battery of an electric vehicle at the station; to supply electricity for the station operation; provide electricity for surrounding commercial electrical needs; and can also provide hydrogen for a fuel cell vehicle refueling at the station. The system can be operated in an off-design condition where a smaller proportion of the hydrogen reforming product is generated, and results in a system of less than optimum efficiency. On the other hand, the off-design condition of the station 302 can be employed to generate an amount of electricity, which requires an incremental additional amount of combustion to occur to support the reforming process, thereby resulting in relatively low levels of CO₂ emission.

The system 300 can be equipped with a sulfur removal device to control the SOx emission, and can be arranged to include a fuel cell stage which operates according to electrochemical principles, and below 1000° C., and eliminates the formation of NOx in the process.

A significant additional advantage of the energy supply station 302 of the invention is that it achieves total system energy balance without requiring additional fuel and air combustion components. The station can share components of both a reformer system and a fuel cell system, and is capable of providing diverse energy services in a baseload operation. The attractiveness of the system is the environmental advantages, such as zero emission, in an economical station arrangement.

The hydrogen separated from the output medium of the chemical converter can also be processed and/or stored by stage 416 of FIG. 2. The captured hydrogen can be made available for consumption on- or off-site. For example, the hydrogen can be provided to fuel cell vehicles with hydrogen tanks, or can be made available to the on-site generator 314 in order to produce additional power and electricity.

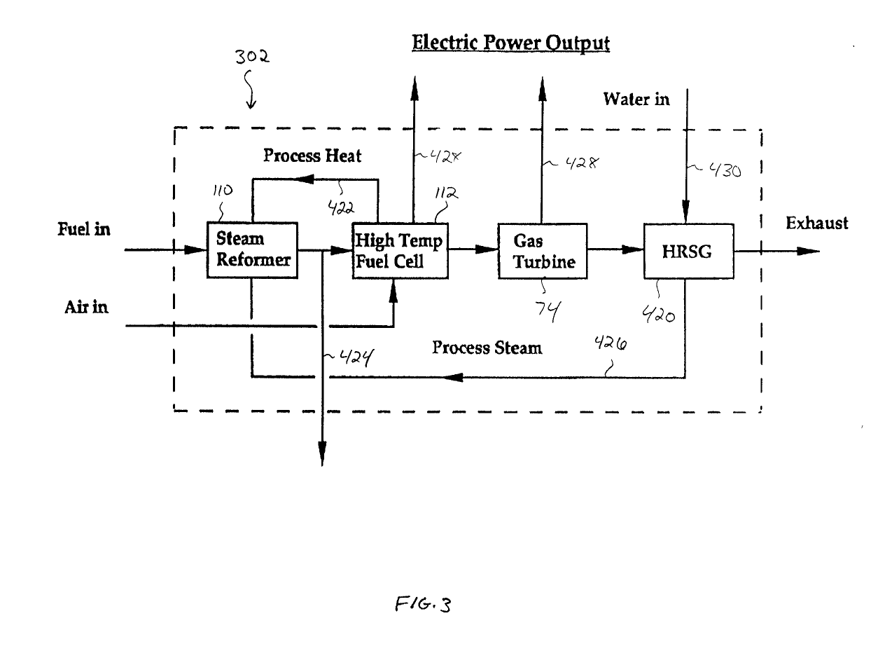

FIG. 3 illustrates another embodiment of the station 302 according to the teachings of the present invention showing the energy and fluid flows occurring therein. Like reference numerals are used throughout to designate like parts. Although illustrated with multiple different stages and components, the station can have any selected number of components and arrangements thereof. The illustrated arrangement is merely illustrative and is not intended to be construed in a limiting sense. The description of the stages and components previously described need not be reproduced below. The illustrated station 302 illustrates a high efficiency co-production system that includes a steam reformer positioned to reform an input fuel in the presence of a reforming agent and a catalyst into a hydrogen rich output medium. A portion of the reformed fuel can be introduced to the fuel cell 112, where it electrochemically reacts with an oxidizer reactant, such as air, to produce an output exhaust and electricity 428. The reformer can utilize the waste heat from the fuel cell as the process heat 422 to conduct the reforming reaction. The remaining portion of the hydrogen rich output medium 424 can be used for other purposes.

The illustrated fuel cell 112 produces an output exhaust that can be introduced to an optional gas turbine assembly 74, which converts the exhaust into rotary energy. The gas turbine produces electricity 428 and an exhaust stream, which in turn is introduced to a boiler, such as a heat recovery steam generator (HRSG) 420. The turbine exhaust introduced to the HRSG converts an input fluid 430, such as water, into steam 426 as it passes therethrough. The resultant steam 426 produced by the HRSG can be utilized by the reformer 110 to reform the input fuel.

The illustrated station 302 employs a fuel cell, reformer, and an optional turbine to form an energy efficient power station having about 45% electrical efficiency plus a 25% chemical efficiency, resulting in an electrical /chemical co-production efficiency of about 70%. The performance of this integrated fuel cell/reformer system is, as shown in FIG. 3, enhanced by the full utilization of the waste heat from the high temperature fuel cell to provide the reformer with the process heat 422 and the process steam 426 for the reforming reaction.

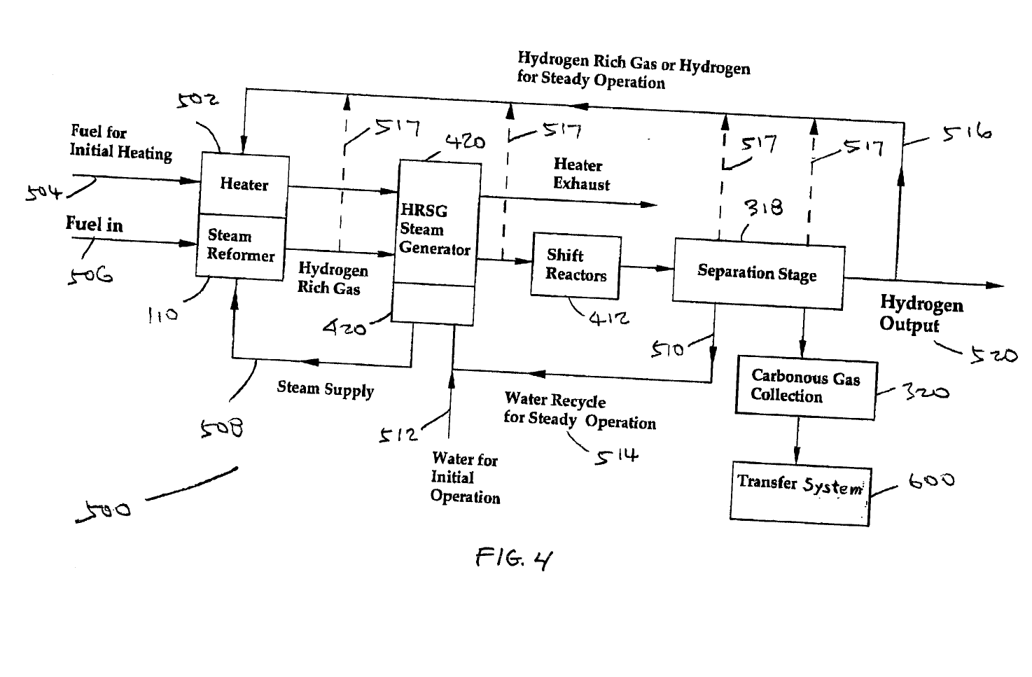

FIG. 4 illustrates an optional embodiment of a zero/low emission reforming apparatus 500 according to the teachings of the present invention showing the energy and fluid flows occurring therein. Like reference numerals are used throughout to designate like parts. The illustrated arrangement is merely illustrative and is not intended to be construed in a limiting sense.

Once the system reaches a steady operation at a required temperature, the heating requirement for the reforming apparatus 500 can be met by recycling a portion of the hydrogen gas produced by the system during operation. Subsequently, the heating stream would not incur any carbon emission. In some embodiments, this method produces about 85% efficiency. This efficiency is about the same as procedures using a hydrocarbon fuel for the heating source, but the use of hydrocarbon fuel would yield about 20% less in production capacity with the same hardware. The reforming apparatus 500 is also beneficial in that it provides CO₂ in the output medium in an isolated state from N₂ and allows for ease of collection and sequestration.

The optional reforming apparatus 500 illustrated in FIG. 4 provides benefits in efficiency and zero emissions. The optional reforming apparatus 500 uses a portion of hydrogen 516 from the hydrogen output 520 as the fuel for the heater 502 to a heat exchanger, such as the HRSG 420. In this way, a separate fuel source 504 for the heater 502 is only required during start up of the reforming apparatus 500.

As illustrated in FIG. 4, the fuel source 504 may be provided to the heater 502 for initial heating during startup. The fuel source 504 may provide any type of fuel capable of generating heat in the heater 502. Examples include gasoline, natural gas, propane, kerosene or other combustible or flammable fluids or gasses. Optionally, the fuel source 504 may be hydrogen stored during a previous operation of the reforming apparatus 500. In the illustrated embodiment, the HRSG 420 receives hot exhaust from the heater 502.

The heater 502 provides heat to support the reforming reaction in the steam reformer 110, which mixes fuel with a reforming agent with the presence of a catalyst, to process fuel to create an output medium of hydrogen-rich gas having one or more of H₂, H₂O, CO, CO₂, and S. The reforming agent according to an embodiment of the present invention is preferably steam. Examples of catalysts include nickel and nickel oxide. In the illustrated embodiment, the output medium is output to the HRSG 420.

The HRSG 420 utilizes at least one of the output medium and the exhaust from the heater 502 to provide heat to produce steam in the HRSG 420. The output medium travels from the HRSG 420 through shift reactors 412 to enrich the hydrogen content and reaches a separation stage 318 capable of removing respectively water and carbonous gas, such as CO₂ and CO, and sulfur from the output medium. A fluid input 512, such as a water input, is provided for the initial operation of the reforming apparatus 500. However, the separation stage 318 provides recycling of water by condensation during steady-state operation and therefore does not need the fluid input 512 after initial operation. Optionally, the fluid input 512 may be provided by water stored during previous operation of the reforming apparatus. The separation stage 318 outputs water 514 to the HRSG 420, which heats the water in order to provide steam 508 to the steam reformer 110, as described above and illustrated in FIG. 4.

After exiting the separation stage 318, the hydrogen-rich output medium is divided such that a sufficient amount of hydrogen 516 is provided back to the heater 502 to function as the fuel for the heater 502. Ideally, the output medium from the separation stage 318 will be pure hydrogen. In some embodiments, approximately 20% of the amount of hydrogen output 520 is provided to the heater 502. The remaining hydrogen output is then provided for further processing as described above.

Alternatively or in addition, the hydrogen-rich gas output medium exiting any stage prior to entering the HRSG 420 or the shift reactors 412, or after exiting from the shift reactors 412, can optionally be provided to the heater 502 in order to provide gaseous fuel for the heater 502. This option improves the emission performance of the heater 502.

Another optional alternative or variation involves providing a portion 517 of the output medium that has been processed through a portion of the separation stage 318 to the heater 502 as described above without passing through the full separation stage 318. Benefits may include the ability to remove all or a portion of water or other non-flammable or non-combustible components of the output medium before providing a portion of the remaining output medium to the heater 502 as fuel.

The optional reforming apparatus 500 described above and illustrated in FIG. 4 will be understood by one of ordinary skill to be capable of implementation in many variations. The reforming apparatus 500 is able to reduce or eliminate emissions to the atmosphere.

As used herein, the term “hydrogen rich gas” is intended to include a fluid or gas rich in hydrogen, and may include any number of other types of fluids, gases or gas species, such as residual gases including CO₂, CO, H₂O, and unprocessed or unreformed fuel. As used herein, the term “pure hydrogen” involves H₂ without residual gases. As used herein, the term “hydrogen output” can be the fully processed output through the reforming and treatment stages as shown in FIG. 4. Alternatively, the hydrogen output can be output from the reformer or any stage thereafter.

It will thus be seen that the invention efficiently attains the objects set forth above, among those made apparent from the preceding description. Since certain changes may be made in the above constructions without departing from the scope of the invention, it is intended that all matter contained in the above description or shown in the accompanying drawings be interpreted as illustrative and not in a limiting sense.

It is also to be understood that the following claims are to cover generic and specific features of the invention described herein, and all statements of the scope of the invention which, as a matter of language, might be said to fall therebetween.

Having described the invention, what is claimed as new and desired to be secured by Letters Patent is:

1. An energy supply station for converting hydrocarbon fuel into at least one of hydrogen and electricity for subsequent delivery to a vehicle, said station comprising
one or more chemical converters positioned to receive fuel and for processing the fuel to form an output medium including carbon dioxide,
a separation stage for separating a chemical component from the output medium,
a collection element in fluid circuit with the separation stage for collecting the carbon dioxide, and
a vehicle interface for interfacing with the vehicle.

2. A co-production energy supply station for producing hydrogen and electricity from a hydrocarbon fuel, said station comprising
a plurality of chemical converters positioned to receive the hydrocarbon fuel and for processing the fuel to form an output medium including carbon dioxide, said chemical converters also generating the hydrogen and the electricity,
a separation stage for separating a chemical component from the output medium, and
a storage element in fluid circuit with the separation stage for storing the hydrogen before being dispensed.

3. The energy supply station of claim 1 or 2, wherein the hydrocarbon fuel includes one of natural gas, coal gas, propane, naphtha, gasoline, diesel fuel, methanol, and biogas.

4. The energy supply station of claim 1 or 2, further comprising a fuel treatment element for pre-treating the fuel prior to introduction to at least one of the chemical converters.

5. The energy supply station of claim 1 or 2, further comprising one or more vaporizers for heating and vaporizing a liquid reforming agent prior to introduction to at least one of the chemical converters.

6. The energy supply station of claim 1 or 2, further comprising one or more evaporators for heating and evaporating the fuel prior to introduction to at least one of the chemical converters.

7. The energy supply station of claim 5, wherein said vaporizer comprises a steam boiler or a heat recovery steam generator.

8. The energy supply station of claim 5, further comprising a mixer in fluid circuit with the vaporizer and adapted to receive the vaporized reforming agent and the fuel, said mixer being adapted to evaporate the fuel and to mix the reforming agent with the fuel.

9. The energy supply station of claim 8, further comprising a secondary heating stage disposed between the vaporizer and the mixer for heating the reforming agent prior to introduction to the mixer.

10. The energy supply station of claim 1 or 2, wherein the chemical converter comprises a reformer and the output medium includes a hydrogen output, water and carbon dioxide, and wherein the separation stage is adapted to isolate individually at least one of the hydrogen, water and carbon dioxide in the output medium.

11. The energy supply station of claim 10, further comprising means for supplying a reforming agent to the reformer suitable for converting the fuel into hydrogen and carbon monoxide as the products of an intermediate reaction that occurs therein.

12. The energy supply station of claim 11, wherein the reforming agent is one of air, water and steam.

13. The energy supply station of claim 10, further comprising a treatment stage for treating a reforming agent prior to introduction to the reformer.

14. The energy supply station of claim 13, wherein the treatment stage comprises a de-ionizer or a vaporizer.

15. The energy supply station of claim 14, wherein the de-ionizer processes the reforming agent with one of a de-ionizing resin and reverse osmosis.

16. The energy supply station of claim 1, wherein the chemical converter comprises at least one reformer and the output medium includes hydrogen, water and carbon dioxide, wherein the vehicle interface is configured to deliver hydrogen to the vehicle.

17. The energy supply station of claim 1 or 2, wherein said chemical converter comprises at least one fuel cell, and wherein said fuel cell produces electricity.

18. The energy supply station of claim 1, wherein said chemical converter comprises at least one fuel cell, and wherein said fuel cell produces electricity, and wherein said vehicle interface is adapted to exchange electricity between the vehicle and the station.

19. The energy supply station of claim 17, wherein the fuel cell is one of a solid oxide fuel cell, molten carbonate fuel cell, phosphoric acid fuel cell, alkaline fuel cell, and proton exchange membrane fuel cell.

20. The energy supply station of claim 1 or 2, further comprising a generator for producing electricity.

21. The energy supply station of claim 20, wherein the generator comprises at least one of a fuel cell, a gas turbine, an internal combustion engine and a sterling engine assembly.

22. The energy supply station of claim 20, wherein said generator comprises a fuel cell positioned to receive the hydrogen output of the reformer for electrochemically converting the hydrogen in the presence of an oxidant into electrical energy.

23. The energy supply station of claim 20, wherein the generator is a fuel cell, said fuel cell being one of a solid oxide fuel cell, molten carbonate fuel cell, phosphoric acid fuel cell, alkaline fuel cell, and proton exchange membrane fuel cell.

24. The energy supply station of claim 20, wherein said generator is selectively coupled to the vehicle interface to deliver electricity to the vehicle.

25. The energy supply station of claim 1 or 2, further comprising an inverter for inverting D.C. electricity generated by said chemical converter into AC current.

26. The energy supply station of claim 1 or 2, further comprising one or more of
a de-sulfurization unit for removing sulfur from the fuel or output medium,
at least one of a low and high temperature shift reactor for converting carbon monoxide and steam within the output medium into carbon dioxide and hydrogen, and
a hydrogen processor for processing hydrogen present within the output medium.

27. The energy supply station of claim 26, wherein the hydrogen processor comprises one of a mechanical compressor and an electrochemical compressor.

28. The energy supply station of claim 27, wherein the electrochemical compressor comprises one of a phosphoric acid, alkaline, and proton exchange membrane device.

29. The energy supply station of claim 1 or 2, wherein said output medium of said chemical converter includes steam, and wherein said separation stage comprises means for condensing the steam from the output medium, thereby enabling the separation of hydrogen and carbon dioxide from the output medium.

30. The energy supply station of claim 1 or 2, wherein said separation stage separates hydrogen from the output medium.

31. The energy supply station of claim 30, wherein said separation stage isolates said hydrogen from said output medium by one of physical absorption, adsorption, low temperature distillation, high pressure liquefaction, membrane, enzyme, and molecular sieve separation of CO₂.

32. The energy supply station of claim 1 or 2, wherein said separation stage comprises one or more of means for forming a liquid or solid hydrogen compound to isolate hydrogen therefrom; means for cooling the output medium of the chemical converter to separate hydrogen therefrom; means for pressurizing the output medium of the chemical converter to separate hydrogen therefrom; and means for membrane filtering the output medium of the chemical converter to separate hydrogen therefrom.

33. The energy supply station of claim 1 or 2, further comprising a storage unit for storing the hydrogen separated from the output medium by said separation stage.

34. The energy supply station of claim 33, further comprising means for storing said hydrogen in said storage unit in one of a compressed gas state, solid state, aqueous state, and refrigerated state.

35. The energy supply station of claim 34, further comprising means for storing said hydrogen in said storage unit in an aqueous state in at least one of the compounds NaBH₄, KBH₄ and LiBH₄, which release hydrogen in the presence of a selected catalyst.

36. The energy supply station of claim 1 or 2, further comprising two or more chemical converters, said chemical converters including a steam reformer and a high temperature fuel cell, wherein the capacity of each is determined by the thermal energy matching characteristics of the fuel cell and reformer without requiring additional combustion heating, wherein reformer performs an endothermic reforming reaction and the fuel cell performs an exothermic reaction, wherein the reformer has a capacity larger than the chemical matching needs of the fuel cell, thereby allowing excess reformed fuel generated by the reformer to be made available for hydrogen production.

37. The energy supply station of claim 1 or 2, further comprising a plurality of chemical converters, wherein said chemical converters include a reformer for reforming the fuel into hydrogen and a fuel cell for generating electricity, wherein the ratio of the co-production of electrical energy to hydrogen energy is about 2 to 1.

38. The energy supply station of claim 1 or 2, further comprising a plurality of chemical converters, wherein said chemical converters include a reformer for reforming the fuel into hydrogen and a fuel cell for generating electricity, wherein the station can be operated in a first condition for producing less hydrogen with said reformer to lower co-production efficiency, or in a second condition for producing less electricity with said fuel cell, thereby requiring thermal energy from a combustion process for supporting the reforming process of the reformer to achieve low CO₂ emission levels.

39. The energy supply station of claim 2, further comprising a collection unit for collecting the carbon dioxide in the output medium before being disposed of.

40. The energy supply station of claim 2, wherein said storage element comprises a composite, polymer-lined storage tank.

41. A method for co-producing hydrogen and electricity in a station from a hydrocarbon fuel, comprising the steps of
co-producing hydrogen and electricity with a plurality of chemical converters by processing the fuel to form an output medium having carbon dioxide,
separating a chemical component from the output medium, and
storing the hydrogen before being dispensed.

42. The method of claim 41, wherein the hydrocarbon fuel includes one of natural gas, coal gas, propane, naphtha, gasoline, diesel fuel, methanol and biogas.

43. The method of claim 41, further comprising the step of pre-treating the fuel prior to introduction to at least one of the chemical converters.

44. The method of claim 41, further comprising the step of heating and vaporizing a liquid reforming agent prior to introduction to at least one of the chemical converters.

45. The method of claim 41, further comprising the step of heating and evaporating the fuel prior to introduction to at least one of the chemical converters.

46. The method of claim 41, further comprising the step of vaporizing a liquid reforming agent prior to introduction to the chemical converters, wherein said vaporizer comprises a steam boiler or a heat recovery steam generator.

47. The method of claim 41, further comprising the step of vaporizing and mixing a reforming agent with the fuel.

48. The method of claim 47, further comprising the steps of providing a mixer for vaporizing and mixing the reforming agent and the fuel, and heating the reforming agent prior to introduction to the mixer.

49. The method of claim 41, wherein one or more of the chemical converters is a reformer and the output medium generated thereby includes hydrogen, water and carbon dioxide, wherein the step of separating comprises the step of individually isolating at least one of the hydrogen, water and carbon dioxide in the output medium.

50. The method of claim 41, wherein one or more of the chemical converters is a reformer, further comprising the step of supplying a reforming agent to the reformer for converting the fuel into hydrogen and carbon monoxide as the products of an intermediate reaction that occurs therein.

51. The method of claim 44, wherein the reforming agent is one of air, water and steam.

52. The method of claim 50, further comprising the step of treating the reforming agent prior to introduction to the reformer with a treatment stage.

53. The method of claim 52, wherein the treatment stage comprises a de-ionizer or a vaporizer.

54. The method of claim 53, wherein the de-ionizer processes the reforming agent with one of a de-ionizing resin and reverse osmosis.

55. The method of claim 41, wherein the chemical converters comprise at least one reformer and the output medium includes hydrogen, water and carbon dioxide, further comprising the step of delivering hydrogen to a vehicle through a vehicle interface.

56. The method of claim 41 or 49, wherein said chemical converters comprise at least one fuel cell, and wherein said fuel cell produces electricity.

57. The method of claim 56, further comprising the step of providing a vehicle interface adapted to exchange electricity between the vehicle and the station.

58. The method of claim 56, wherein the fuel cell is one of a solid oxide fuel cell, molten carbonate fuel cell, phosphoric acid fuel cell, alkaline fuel cell, and proton exchange membrane fuel cell.

59. The method of claim 41, further comprising the step of providing a generator for producing electricity.

60. The method of claim 59, wherein the generator comprises at least one of a fuel cell and a gas turbine, an internal combustion engine and a sterling engine assembly.

61. The method of claim 59, wherein the said generator comprises a fuel cell positioned to receive the hydrogen output of the reformer for electrochemically converting the hydrogen in the presence of an oxidant into electrical energy.

62. The method of claim 59, wherein the generator is a fuel cell, said fuel cell being one of a solid oxide fuel cell, molten carbonate fuel cell, phosphoric acid fuel cell, alkaline fuel cell, and proton exchange membrane fuel cell.

63. The method of claim 59, wherein said generator is selectively coupled to a vehicle interface for delivering electricity to a vehicle.

64. The method of claim 41, further comprising the step of inverting D.C. electricity generated by said chemical converter into AC current.

65. The method of claim 41, further comprising one or more of
a de-sulfurization unit for removing sulfur from the fuel or output medium,
at least one of a low and high temperature shift reactor for converting carbon monoxide and steam within the output medium into carbon dioxide and hydrogen, and
a hydrogen processor for processing hydrogen present within the output medium.

66. The method of claim 65, wherein the hydrogen processor comprises one of a mechanical compressor and an electrochemical compressor.

67. The method of claim 66, wherein the electrochemical compressor comprises one of a phosphoric acid, alkaline, and proton exchange membrane device.

68. The method of claim 41, wherein said output medium of said chemical converter includes steam, and wherein said step of separating comprises the step of condensing the steam from the output medium, thereby enabling the separation of hydrogen and carbon dioxide from the output medium.

69. The method of claim 41, wherein said separation step comprises the step of separating hydrogen from the output medium.

70. The method of claim 69, further comprising the step of isolating said hydrogen from said output medium by one of physical absorption, adsorption, low temperature distillation, high pressure liquefaction, membrane, enzyme, and molecular sieve separation of CO₂.

71. The method of claim 41, wherein said step of separating is performed with a separation stage, said separation stage comprising one or more of means for forming a liquid or solid hydrogen compound to isolate hydrogen therefrom; means for cooling the output medium of the chemical converter to separate hydrogen therefrom; means for pressurizing the output medium of the chemical converter to separate hydrogen therefrom; and means for membrane filtering the output medium of the chemical converter to separate hydrogen therefrom.

72. The method of claim 41, further comprising the step of storing hydrogen separated from the output medium.

73. The method of claim 41, further comprising the step of storing hydrogen separated from the output medium in a storage unit in one of a compressed gas state, solid state, aqueous state, and refrigerated state.

74. The method of claim 73, further comprising the step of storing said hydrogen in said storage unit in an aqueous state in at least one of the compounds NaBH₄, KBH₄ and LiBH₄, which release hydrogen in the presence of a selected catalyst.

75. The method of claim 41, wherein said chemical converters include a steam reformer and a high temperature fuel cell, further comprising the step of determining the capacity of said fuel cell and said reformer by the thermal energy matching characteristics of the fuel cell and reformer without requiring additional combustion heating, wherein the reformer performs an endothermic reforming reaction and the fuel cell performs an exothermic reaction, wherein the reformer has a capacity larger than the chemical matching needs of the fuel cell, thereby allowing excess reformed fuel generated by the reformer to be made available for hydrogen production.

76. The method of claim 41, wherein said chemical converters include a reformer for reforming the fuel into hydrogen and a fuel cell for generating electricity, wherein the ratio of the co-production of electrical energy to hydrogen is about 2 to 1.

77. The method of claim 41, wherein said chemical converters include a reformer for reforming the fuel into hydrogen and a fuel cell for generating electricity arranged in the station, wherein the station can be operated in a first condition for producing less hydrogen with said reformer to lower co-production efficiency, or in a second condition for producing less electricity with said fuel cell, thereby requiring thermal energy from a combustion process for supporting the reforming process of the reformer to achieve low CO₂emission levels.

78. The method of claim 41, further comprising the step of collecting the carbon dioxide before being disposed of.

79. The method of claim 41, wherein said step of storing comprises the step of storing the hydrogen in a composite, polymer-lined storage tank.

80. The energy supply station of claim 10, wherein at least one of the chemical converters comprises a reformer for reforming the fuel into hydrogen and a portion of the hydrogen output is used as an energy source for providing heat to the reformer.

81. The energy supply station of claim 16, wherein at least one of the chemical converters comprises a reformer for reforming the fuel into hydrogen and wherein a portion of said hydrogen reformed from said fuel is used as an energy source for providing heat to the reformer.

82. The energy supply station of claim 30, wherein at least one of the chemical converters comprises a reformer for reforming the fuel into hydrogen and wherein a portion of said hydrogen reformed from said fuel is used as an energy source for providing heat to the reformer.

83. The energy supply station of claim 10, wherein at least one of the chemical converters comprises a reformer for reforming the fuel into hydrogen and a portion of the hydrogen separated from the output medium by the separation stage is used as an energy source for providing heat to the reformer.

84. The energy supply station of claims 1 or 2, wherein the energy supply station mixes steam with the fuel and is capable of realizing a net gain of at least about 50% in hydrogen yield from the fuel supply.

85. The energy supply station of claim 84, wherein the energy supply station mixes steam with the fuel and is capable of realizing a net gain in chemical energy content from the fuel supply.

86. The energy supply station of claim 1 or 2, wherein the energy supply station mixes steam with the fuel and is capable of realizing a net gain in chemical energy content from the fuel supply.

87. The energy supply station of claim 1 or 2, wherein the energy supply station is capable of stripping hydrogen from a water molecule by the use of a chemical process at a temperature less than 1000° C.

88. An energy supply station for reforming hydrocarbon fuel into hydrogen, comprising:
an endothermic reformer for reforming the fuel and producing an output medium including hydrogen, and
a heater for providing heat to the reformer,
wherein a portion of the output hydrogen is used as an energy source for the heater.

89. The energy supply station of claim 88, further comprising a heat exchanger receiving an exhaust of the heater and the output medium of the reformer and utilizing a portion of heat received from the exhaust of the heater and the output medium of the reformer for steam generation.

90. The energy supply station of claim 89, further comprising,
a separation stage receiving the output medium exiting from the heat exchanger,
wherein the separation stage is adapted to condense out water from the output medium and supply water to the heat exchanger for said steam generation for use by the reformer.

91. The energy supply station of claim 89, further comprising,
a shift reactor adapted to receive the output medium exiting from the heat exchanger and enrich the hydrogen content of the output medium,
a separation stage adapted to yield hydrogen and supply hydrogen to a heater to provide heat to the reformer.

92. The energy supply station of claim 88 wherein the heater also provides heat directly to the reformer.

93. The energy supply station of claims 1 or 2, where the CO₂ produced as the by-product is collected and transported through a fluid conduit to a location for treatment, commercial use, disposition or further sequestration.

94. The energy supply station of claims 1, 2, 88, or 90, wherein the station when operating as a zero emission station (ZES) exports hydrogen for consumption while NOx, SOx and carbonous species, and unreacted fuel are collected for disposal.

95. The energy supply station of claim 1, wherein said collection element includes a transportation system to deposit the carbon dioxide below a surface of an ocean.

96. The energy supply station of claim 2, further comprising a collection element in fluid circuit with the separation stage and including a transportation system to deposit the carbon dioxide below a surface of an ocean.

97. The energy supply station of claims 95 or 96, wherein said transportation system deposits the carbon dioxide at an ocean depth of at least 1000 feet.

98. The energy supply station of claims 1 or 88, wherein the collection element is adapted to collect the output medium after the hydrogen is removed from the output medium, thereby preventing emission of non-hydrogen gases to the atmosphere.

99. The energy supply station of claims 2 or 90, further comprising a collection element in fluid circuit with the separation stage and adapted to collect the output medium after the hydrogen is removed from the output medium, thereby preventing emission of non-hydrogen gases to the atmosphere.

100. A method for reforming hydrocarbon fuel into hydrogen, comprising the steps of:
providing the fuel to an endothermic reformer,
utilizing a heater to provide heat to the reformer,
reforming the fuel, thereby producing an output medium including hydrogen, and
directing a portion of the output hydrogen to power the heater.

101. The method of claim 100, further comprising the steps of,
receiving an output of the heater and the output medium of the reformer at a heat exchanger, and
utilizing a portion of heat received from the exhaust of the heater and the output medium of the reformer for producing steam.

102. The method of claim 100, further comprising the steps of,
receiving the output medium exiting from the heat exchanger at a separation stage,
condensing the water from the output medium in the separation stage, and
supplying water to the heat exchanger for producing steam for the operation of the reformer.

103. The method of claim 100, further comprising the steps of,
receiving the output medium exiting from the heat exchanger at a separation stage, and
supplying hydrogen from the separation stage to produce fuel for the heater to provide heat to the reformer.

104. The method of claim 100, further comprising, before said step of receiving the output medium exiting from the heat exchanger, the step of enriching a hydrogen content of the output medium.

105. The method of claim 100, further comprising the step of preventing emission of a carbonous gas from output medium to the atmosphere by the energy supply station.

106. The energy supply station of claim 39, further comprising a transfer system coupled to the collection unit for transferring the carbon dioxide therefrom.

107. The method of claim 78, further comprising the step of transferring the carbon dioxide therefrom.
